(19) United States
(12) Patent Application Publication
(10) Pub. No.: US 2011/0235141 A1
(43) Pub. Date: Sep. 29, 2011

(54) Spot Color Matching Mechanism

(76) Inventors: Vladimir V. Shestak, Boulder, CO (US); Yue Qiao, Longmont, CO (US)

(21) Appl. No.: 12/729,439

(22) Filed: Mar. 23, 2010

(51) Int. Cl. H04N 1/46

(52) U.S. Cl. 358/504

(57) ABSTRACT

An apparatus is disclosed. The apparatus includes a color image recording device to measure a spot color on a medium and a color matching module to determine a perceptual color difference between the measured spot color and a reproduction color as a function of color values in a color space and to optimize the function to establish a minima.

### FIELD OF THE INVENTION

This invention relates generally to the field of printing systems. More particularly, the invention relates to color matching for a printing system.

### BACKGROUND

Growth in color management has resulted in an increase in software packages that are used to generate International Color Consortium (ICC) profiles. ICC profiles describe color attributes of a particular device or viewing requirement by defining a mapping between a source or target color space and a Profile Connection Space (PCS), such as either CIELAB (L*a*b*) or CIEXYZ.

However, print customers often request that one or more colors specified in a print job accurately match desired colors. While some colors in a print job are not needed, or may be reproduced within some tolerance range, other colors are essential and require accurate color reproduction. For example, a customer may request a set of colors printed with an old printer of a different vendor be accurately matched by a new color printer. Another example may include finding an accurate Cyan, Magenta, Yellow, Black (CMYK) match for a given spot color that belongs to a certain spot color family (e.g., Pantone). Nonetheless, a match for such a spot color may not be available in the printer's color space.

Therefore, an accurate spot color matching mechanism is desired.

### SUMMARY

In one embodiment, an apparatus is disclosed. The apparatus includes a color image recording device to measure a spot color on a medium and a color matching module to determine a perceptual color difference between the measured spot color and a reproduction color as a function of color values in a color space and to optimize the function to establish a minima In another embodiment, a method is disclosed. The method includes measuring a spot color on a medium in a device independent color space, converting the measured spot color to a profile color value for a printer, generating a test chart by sampling a color space within a distance in each dimension from the profile color value, determining color differences between the measured color value and each test chart sample value, generating a functional dependency between an independent color space and a color space of the printer, searching to find a color combination that minimizes color difference between a spot color and a printer reproduction of the spot color in the independent color space and applying the local minimum value to a transform that translates an input color space into the color space of the printer.

### BRIEF DESCRIPTION OF THE DRAWINGS

A better understanding of the present invention can be obtained from the following detailed description in conjunction with the following drawings, in which:

FIG. 1 illustrates one embodiment of a printer;

FIG. 2 illustrates a block diagram of one embodiment of a color matching system;

FIG. 3 is a flow diagram illustrating one embodiment of a process for spot color matching;

FIG. 4 illustrates one embodiment of a local minimum search process;

FIG. 5 illustrates one embodiment of a translation transform; and

FIG. 6 illustrates one embodiment of a computer system.

### DETAILED DESCRIPTION

A spot color matching mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

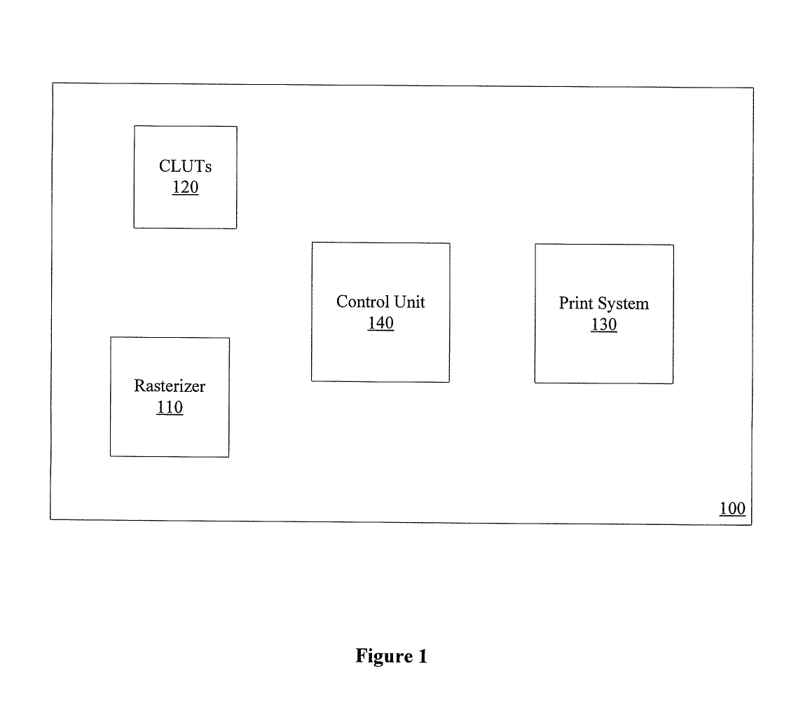

FIG. 1 illustrates one embodiment of a printer 100. Printer 100 includes a rasterizer 110 that is implemented to convert vector information received at printer 100 into a raster format. Particularly, rasterizer 110 generates a raster scan of a received image that is to be stored as scan line data in a memory array (not shown).

Printer 100 also includes color lookup tables (CLUTs) 120. CLUTs 120 support ICC profiles used in printer 100 to enable the use of different color transforms, where each transform is tailored for a different effect. According to one embodiment, each profile includes up to 6 CLUT's, three for input (AtoB tables, which convert from device space to PCS, and three for output (BtoA tables, that convert from PCS to device space). Printer 100 includes a print system 130 that physically applies print job data on a print medium. Control unit 140 is also included with in printer 100 to control the operation of print system 130.

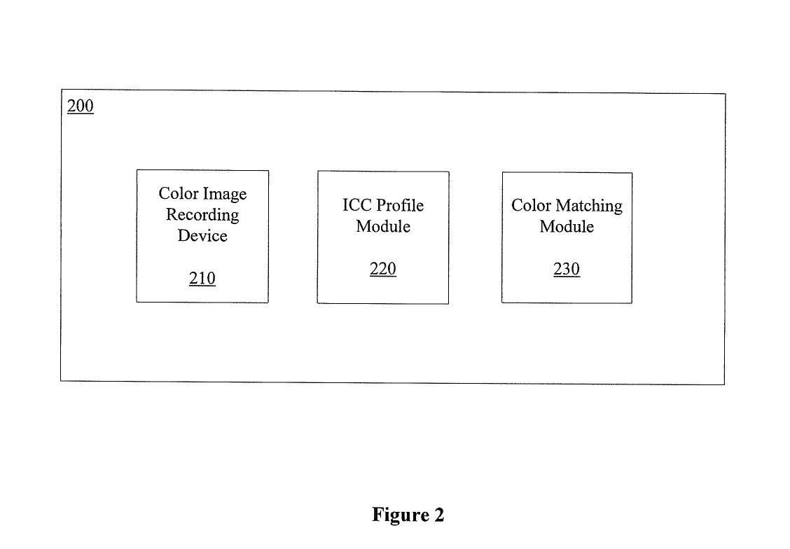

FIG. 2 is a block diagram of one embodiment of a spot color matching system 200. In one embodiment, spot color matching system 200 may reside as a component of printer 100 described with respect to FIG. 1. However in other embodiments, spot color matching system may be an independent device, or combination of devices, that is communicably coupled to printer 100.

Spot color matching system 200 includes a color image recording device 210, ICC profile module 220 and color matching module 230. Color image recording device 210 measures a spot color printed on a medium (e.g., paper) in a device independent color space (e.g., L*a*b value the custom ink). In one embodiment, color image recording device 210 may be implemented with a scanner, photo spectrophotometer, or any other type of imaging measurement device.

ICC profile module 230 receives an input color space as measured by color image recording device 210 and maps an output to the printer 100 color space (e.g., CMYK). These input and output ICC files are subsequently passed to printer 100. Color matching module 230 provides an optimization of an iterative search that enables printer 100 to reproduce a desired color as close as possible.

In one embodiment, color matching module 230 performs a mathematical model that establishes a perceptual color difference as a function of color values in a color space (e.g., CMYK, or CIELab). Thus, upon measuring the spot color in the L*a*b space a search is conducted with respect to color metrics used to establish a color difference between the L*a*b specification of the desired color and the corresponding reproduction on printer 100 (e.g., ΔE, CIE94, ΔE, CIE 2000 ΔE). Subsequently, color matching module 230 applies nonlinear optimization techniques to the function to determine a minima.

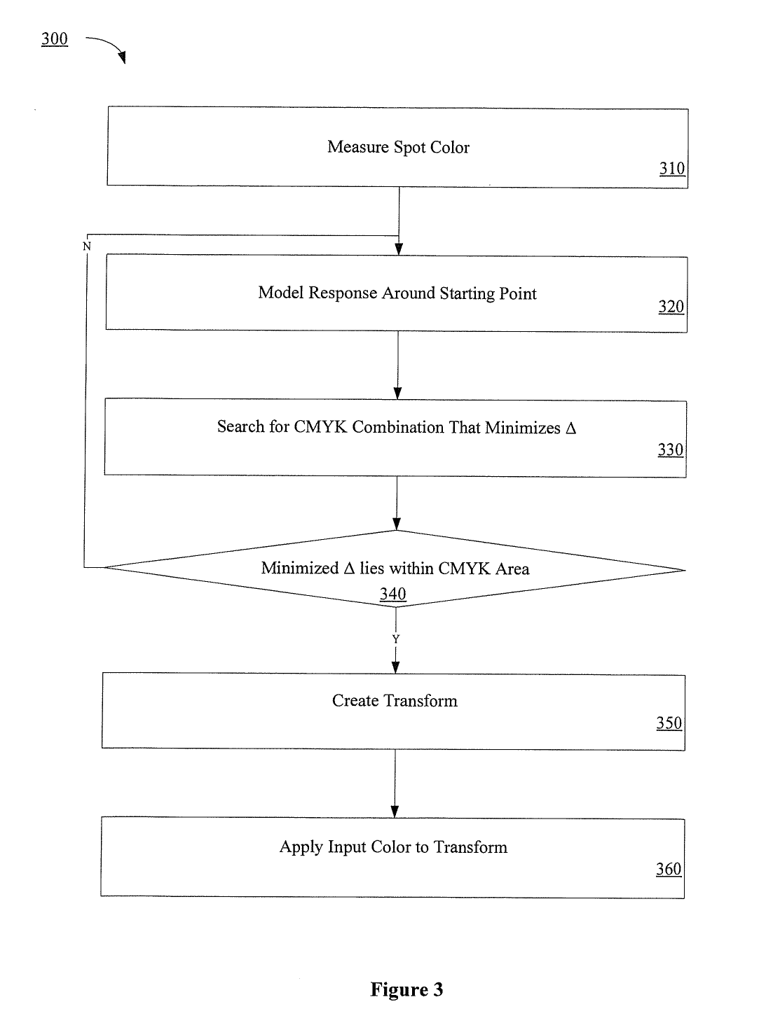

FIG. 3 is flow diagram illustrating one embodiment of a process 300 for spot color matching. Process 300 may be performed by processing logic that may include hardware (e.g., circuitry, dedicated logic, programmable logic, microcode, etc.), software (such as instructions run on a processing device), or a combination thereof. In one embodiment, process 300 is performed by spot color matching system 200.

According to one embodiment of process 300, colors in a print job are specified in the CMYK color space with a desired spot color (e.g., C₀ⁱⁿ M₀ⁱⁿ Y₀ⁱⁿ K₀ⁱⁿ) and a ICC device link structure (or transform) used in printer 100. However in other embodiments, process 300 can implemented using other color spaces (e.g., RGB, L*a*b, Named color space), utilized to modify input/output ICC profiles and PostScript CSA/CRD tables, or used as a basis for standalone accurate spot color matching tools.

At processing block 310, a spot color printed on a medium is measured by color image recording device 210 in a device independent color space and denoted L₀a₀b₀. Subsequently, the printer 100 output ICC profile color value (C₀^{out} M₀^{out} Y₀^{out} K₀^{out}) for the type of medium is selected upon processing L₀a₀b₀ through the ICC profile. Thus, the value C₀^{out} M₀^{out} Y₀^{out} K₀^{out} will serve as the starting point in the search process.

At processing block 320, the printer 100 response around the starting point C₀^{out} M₀^{out} Y₀^{out} K₀^{out} is modeled. To perform this process a test chart is created. In one embodiment, the test chart evenly samples a CMYK color space within a small distance from the starting point C₀^{out} M₀^{out} Y₀^{out} K₀^{out} in each dimension. However in embodiments that do not support CMYK to CMYK transforms, the color difference can be built as a function of measured CIELab value of the CMYK patches, rather than the CMYK values. Thus, the output result would be new CIELab values that go through the output ICC profile to obtain the desired CMYK values.

After creation, the test chart is printed and the response is measured in the L*a*b color space. Subsequently, a color difference Δᵢ between Lᵢaᵢbᵢ and L₀a₀b₀ is computed for each patch i in the test chart. Using patches of the test chart as sample points, a functional dependency between the color difference and the printer 100 CMYK color space (e.g., Δ=f(C, M, Y, K)) is established. In one embodiment, different parametric and non-parametric regression models can be used to establish the functional dependency. In such an embodiment, second or third degree polynomial regression may be used since the printer 100 response in a small region of colors is relatively smooth. In a further embodiment, a cross-validation technique is implemented to achieve the best accuracy of the regression fit.

Using Δ=f(C, M, Y, K), a search is performed to find a CMYK combination that minimizes Δ, processing block 330. In one embodiment, a Newton search for a minimum technique is used for embodiments where the functional dependency is based on a second or third degree polynomial (e.g., the second derivative is available for f(C, M, Y, K)). The result of the search is denoted as C₁^{out} M₁^{out} Y₁^{out} K₁^{out}.

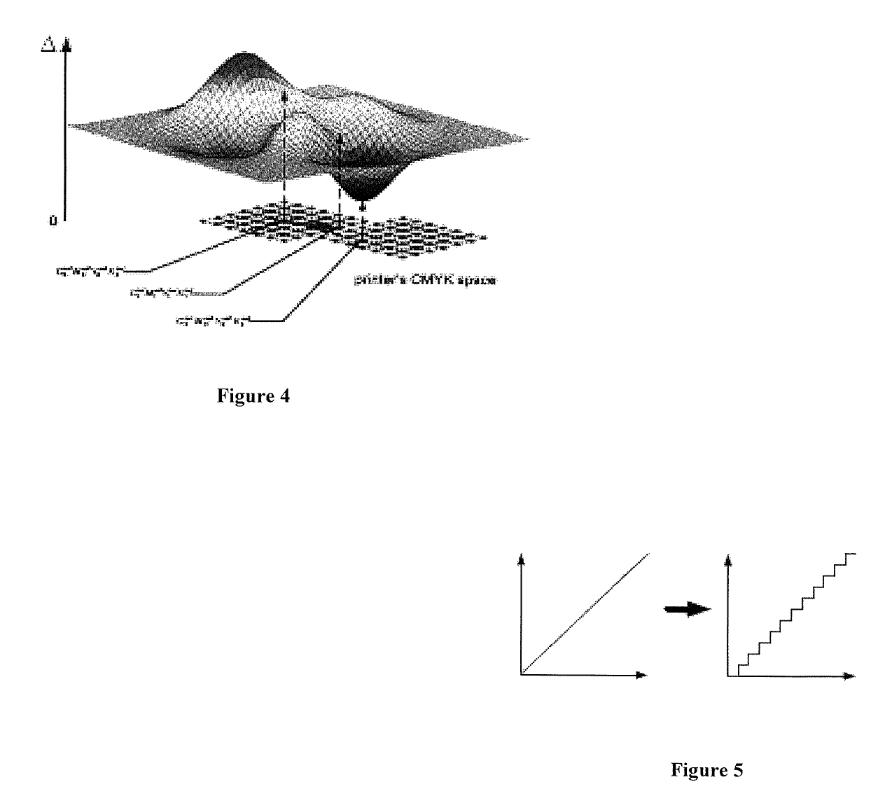

At decision block 340, it is determined whether the search result C₁^{out} M₁^{out} Y₁^{out} K₁^{out} lies inside the CMYK area around C₀^{out} M₀^{out} Y₀^{out} K₀^{out}. If C₁^{out} M₁^{out} Y₁^{out} K₁^{out} does not lie inside the CMYK area around C₀^{out} M₀^{out} Y₀^{out} K₀^{out}, control is returned to processing block 320, where C₁^{out} M₁^{out} Y₁^{out} K₁^{out} is set as a new starting point. FIG. 4 illustrates one embodiment of a search for the minimum A using the Newton search process. As shown in FIG. 4, the final solution C₂^{out} M₂^{out} Y₂^{out} K₂^{out} is found by going through two iterations of processing blocks 320-340. Further, after the first iteration a new area of CMYK space was sampled in the direction determined by a vector from C₀^{out} M₀^{out} Y₀^{out} K₀^{out} to C₁^{out} M₁^{out} Y₁^{out} K₁^{out}.

Referring back to FIG. 3, if it is determined that C₁^{out} M₁^{out} Y₁^{out} K₁^{out} lies inside the CMYK area around C₀^{out} M₀^{out} Y₀^{out} K₀^{out}, a local minimum has been found. Thus at processing block 350, a transform is created that translates an input CMYK color space into the printer's CMYK color space. In one embodiment, the structure of the CMYK-to-CMYK transform includes four one dimensional (1D) input curves, one 4D CLUT, and four 1D output curves.

Assuming that the 4D CLUT has a resolution of N, each of the four 1D input curves is converted to equally spaced N step functions as shown in FIG. 5. This modification will allow any input CMYK value to be mapped exactly onto one of the nodes in the 4D CLUT so that the resultant output CMYK color will be equal to the CMYK entry of that node.

Referring back to FIG. 3, the C₀^{out} M₀^{out} Y₀^{out} K₀^{out} input color is applied to the transform, processing block 360. Further, the node in the transform's 4D CLUT to which the input color is mapped is identified. Subsequently, the CMYK entry of this node is set to the local minimum value.

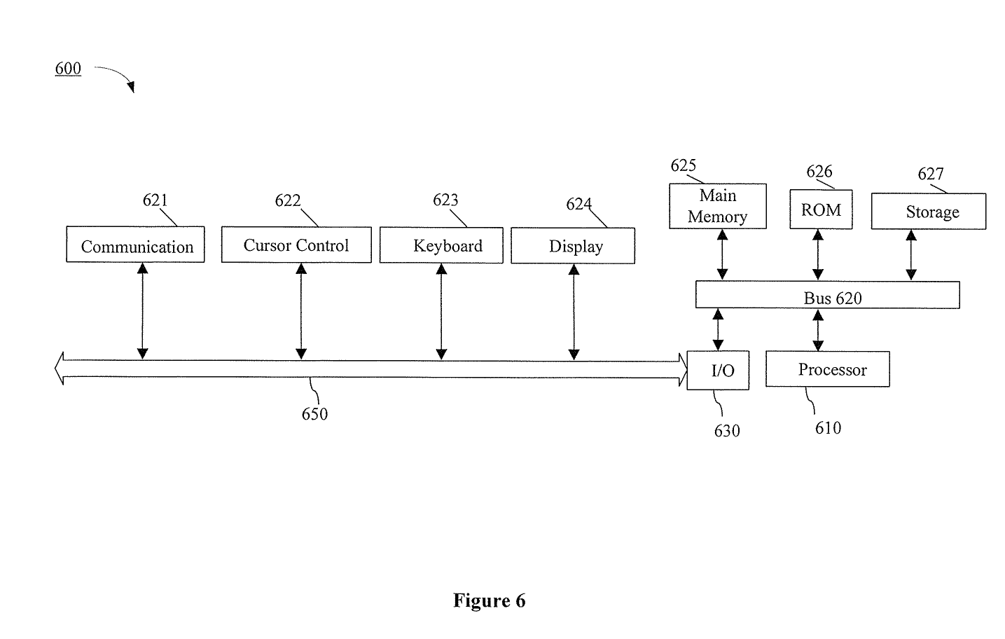

FIG. 6 illustrates a computer system 600 on which spot color matching system 200 described with respect to FIG. 2 may be implemented. Computer system 600 includes a system bus 620 for communicating information, and a processor 610 coupled to bus 620 for processing information. According to one embodiment, processor 610 is implemented using one of the multitudes of ARM™ microprocessors. Nevertheless one of ordinary skill in the art will appreciate that other processors may be used.

Computer system 600 further comprises a random access memory (RAM) or other dynamic storage device 625 (referred to herein as main memory), coupled to bus 620 for storing information and instructions to be executed by processor 610. Main memory 625 also may be used for storing temporary variables or other intermediate information during execution of instructions by processor 410. Computer system 400 also may include a read only memory (ROM) and or other static storage device 626 coupled to bus 620 for storing static information and instructions used by processor 610.

A data storage device 625 such as a magnetic disk or optical disc and its corresponding drive may also be coupled to computer system 600 for storing information and instructions. Computer system 600 can also be coupled to a second I/O bus 650 via an I/O interface 630. A plurality of I/O devices may be coupled to I/O bus 650, including a display device 624, an input device (e.g., an alphanumeric input device 623 and or a cursor control device 622). The communication device 621 is for accessing other computers (servers or clients) via an external data network, for example. The communication device 621 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A computer generated method comprising:
measuring a spot color on a medium in a device independent color space;
converting the measured spot color to a profile color value for a printer;
generating a test chart by sampling a color space within a distance in each dimension from the profile color value;
determining color differences between the measured color value and each test chart sample value;
generating a functional dependency between the color differences and a color space of the printer;
searching to find a color combination that minimizes functional dependency between the color differences and a color space of the printer;
establishing the profile color value as a local minimum value if a search value lies inside a color area around the profile color value; and
applying the local minimum value to a transform that translates an input color space into the color space of the printer.

2. The method of claim 1, further comprising establishing the search value as a second profile color value if the value lies outside a color area around the profile color value.

3. The method of claim 1, further comprising:
generating a second test chart by sampling a color space within a distance in each dimension from the second profile color value;
determining color differences between the measured color value and each test chart sample value;
determining a functional dependency between the color differences and the color space of the printer;
searching to find a color combination that minimizes functional dependency between the color differences and the color space of the printer; and
establishing the second profile color value as a local minimum value if a second search value lies inside a color area around the second profile color value.

4. The method of claim 1, wherein generating the functional dependency is performed using a second or third degree polynomial regression.

5. The method of claim 1, wherein generating the functional dependency is performed using a cross-validation technique.

6. The method of claim 4, wherein the search is performed using a Newton search for a minimum technique.

7. The method of claim 1, wherein the transform includes four one dimensional (1D) input curves, a 4D color lookup table (CLUT), and four 1D output curves.

8. The method of claim 7, wherein each of the input curves is converted to an equally spaced resolution of step functions to enable an input value to be mapped onto a node in the 4D CLUT.

9. An apparatus, comprising:
a color image recording device to measure a spot color on a medium; and
a color matching module to determine a perceptual color difference between the measured spot color and a reproduction color as a function of color values in a color space and to optimize the function to establish a minima.

10. The apparatus of claim 9, further comprising an International Color Consortium (ICC) profile module to convert the measured spot color to a profile color value.

11. The apparatus of claim 9, wherein the color matching module generates a test chart that samples a color space within a distance in each dimension from the profile color value and determines color differences between the measured color value and each test chart sample value.

12. The apparatus of claim 11, wherein the color matching module further generates a functional dependency between the color differences and a color space of a printer, performs a search to find a color combination that minimizes functional dependency between the color differences and the color space of the printer, establishes the profile color value as a local minimum value if a search value lies inside a color area around the profile color value and applies the local minimum value to a transform that translates an input color space into the color space of the printer.

13. The apparatus of claim 12, wherein the color matching module further establishes the search value as a second profile color value if the value lies outside a color area around the profile color value.

14. The apparatus of claim 13, wherein the color matching module further generates a second test chart by sampling a color space within a distance in each dimension from the second profile color value, determines color differences between the measured color value and each test chart sample value, determines a functional dependency between the color differences and the color space of the printer and searches to find a color combination that minimizes functional dependency between the color differences and the color space of the printer and establishes the second profile color value as a local minimum value if a second search value lies inside a color area around the second profile color value.

15. An article of manufacture comprising a machine-readable medium including data that, when accessed by a machine, cause the machine to perform operations comprising:
measuring a spot color on a medium in a device independent color space;
converting the measured spot color to a profile color value for a printer;
generating a test chart by sampling a color space within a distance in each dimension from the profile color value;
determining color differences between the measured color value and each test chart sample value;
generating a functional dependency between the color differences and a color space of the printer;
searching to find a color combination that minimizes functional dependency between the color differences and a color space of the printer;
establishing the profile color value as a local minimum value if a search value lies inside a color area around the profile color value; and
applying the local minimum value to a transform that translates an input color space into the color space of the printer.

16. The article of manufacture of claim 15, wherein the machine-accessible medium includes data that causes the machine to perform further operations comprising establishing the search value as a second profile color value if the value lies outside a color area around the profile color value.

17. The article of manufacture of claim 15, wherein the machine-accessible medium includes data that causes the machine to perform further operations comprising:
generating a second test chart by sampling a color space within a distance in each dimension from the second profile color value;
determining color differences between the measured color value and each test chart sample value;
determining a functional dependency between the color differences and the color space of the printer;
searching to find a color combination that minimizes functional dependency between the color differences and the color space of the printer; and
establishing the second profile color value as a local minimum value if a second search value lies inside a color area around the second profile color value.

18. The article of manufacture of claim 15, wherein generating the functional dependency is performed using a second or third degree polynomial regression.

19. The article of manufacture of claim 18, wherein the search is performed using a Newton search for a minimum technique.

20. The article of manufacture of claim 15, wherein generating the functional dependency is performed using a cross-validation technique.
